(19) United States
(12) Patent Application Publication
(10) Pub. No.: US 2026/0225552 A1
(43) Pub. Date: Aug. 6, 2026

(54) VEHICLE FRONT STRUCTURE

(71) Applicant: TOYOTA JIDOSHA KABUSHIKI KAISHA, Toyota-shi (JP)

(72) Inventor: Masayuki OKANO, Toyota-shi (JP)

(73) Assignee: TOYOTA JIDOSHA KABUSHIKI KAISHA, Toyota-shi (JP)

(21) Appl. No.: 19/396,837

(22) Filed: Nov. 21, 2025

(30) Foreign Application Priority Data
Feb. 4, 2025 (JP) 2025-016618

(51) Int. Cl. B60R 19/18; B60Q 5/00

(52) U.S. Cl. CPC B60R 19/18; B60Q 5/00

(57) ABSTRACT

A vehicle front structure includes an absorber. The absorber includes a recess that provides an internal space, an upper through portion that connects a space above the absorber and the internal space, a lower through portion that connects a communication space in the internal space that is connected to the upper through portion and a space below the absorber, and a pair of sound-shielding portions. The sound-shielding portions partition the communication space, a space adjacent to the communication space in the internal space in a vehicle width direction.

### CROSS-REFERENCE TO RELATED APPLICATION

This application claims priority to Japanese Patent Application No. 2025-016618 filed on February 4, 2025. The disclosure of the above-identified application, including the specification, drawings, and claims, is incorporated by reference herein in its entirety.

### BACKGROUND

### 1. Technical Field

The present disclosure relates to a vehicle front structure.

### 2. Description of Related Art

Japanese Unexamined Patent Application Publication No. 2024-135044 (JP 2024-135044 A) discloses a vehicle front structure. The vehicle front structure includes a horn, a bumper reinforcement provided below the horn, an absorber, and a bumper cover that covers the bumper reinforcement and the absorber from a front side. Here, the absorber is provided forward of the bumper reinforcement and extends in a vehicle width direction along the bumper reinforcement. The bumper cover includes a lower opening portion provided at a position lower than the absorber.

### SUMMARY

An object of the present disclosure is to reduce the weight of the absorber, improve an impact absorption characteristic of the absorber, and increase the volume of horn sound transmitted from the lower opening portion to a front side of a vehicle.

A vehicle front structure according to a first aspect includes

a horn,

a bumper reinforcement provided below the horn and extending in a vehicle width direction, an absorber provided forward of the bumper reinforcement and extending in the vehicle width direction along the bumper reinforcement, and

a bumper cover configured to cover the bumper reinforcement and the absorber from a front side, in which

the bumper cover includes a lower opening portion provided at a position lower than the absorber, and

the absorber includes

a recess that provides an internal space extending in the vehicle width direction between the bumper reinforcement and the absorber,

an upper through portion that connects a space above the absorber and the internal space, a lower through portion that connects a communication space in the internal space, the communication space being connected to the upper through portion, and a space below the absorber, and

a pair of sound-shielding portions that partitions the communication space and a space in the internal space, the space being adjacent to the communication space in the vehicle width direction.

In the present aspect, the vehicle front structure includes the horn, the bumper reinforcement provided below the horn and extending in the vehicle width direction, the absorber, and the bumper cover configured to cover the bumper reinforcement and the absorber from the front side. The absorber is provided forward of the bumper reinforcement and extends in the vehicle width direction along the bumper reinforcement. The bumper cover includes the lower opening portion provided at the position lower than the absorber.

In the present aspect, the absorber includes the recess that provides the internal space extending in the vehicle width direction between the bumper reinforcement and the absorber. Therefore, it is possible to reduce the weight of the absorber and to adjust the impact absorption characteristic.

Since the lower opening portion of the bumper cover is provided at the position lower than the absorber, the sound from the horn may be blocked by the bumper reinforcement and the absorber, and may have difficulty in being transmitted from the lower opening portion to the front side of the vehicle.

Therefore, in the present aspect, the absorber includes the upper through portion that connects the space above the absorber and the internal space, and the lower through portion that connects the communication space in the internal space, the communication space being connected to the upper through portion, and the space below the absorber. Therefore, the sound from the horn provided above the absorber can be transmitted to the side below the absorber through the upper through portion, the communication space, and the lower through portion.

As described above, the recess extends in the vehicle width direction. Therefore, after entering the internal space from the upper through portion, the sound from the horn is transmitted in the recess in the vehicle width direction. This may cause a reduction in the volume of the sound transmitted from the lower opening portion to the front side of the vehicle. Therefore, in the present aspect, the absorber includes the sound-shielding portions. The sound-shielding portions partition the communication space in the internal space provided by the recess, the communication space being connected to the upper through portion, and the space in the internal space, the space being adjacent to the communication space in the vehicle width direction. Therefore, the transmission of the sound in the recess in the vehicle width direction is suppressed, and as a result, the volume of the horn sound transmitted from the lower opening portion to the front side of the vehicle can be increased.

In the embodiment described below, the sound-shielding portion is integrally molded with the same material as the other portions of the absorber, but the sound-shielding portion of the present aspect is not limited thereto.

In the embodiment described below, the vehicle front structure includes an approach notification sound speaker in addition to the horn, but the present aspect is not limited thereto.

In the embodiment described below, the bumper cover does not include an opening portion (upper opening portion) provided at a position above the absorber, but the present aspect is not limited thereto.

With the vehicle front structure according to a second aspect, in the first aspect, a surface on a side of at least one of the sound-shielding portions that faces the communication space has a corrugated shape.

In the present aspect, the surface on the side of at least one of the sound-shielding portions that faces the communication space has the corrugated shape. Therefore, the generation of a standing wave between the sound-shielding portions can be suppressed.

In the embodiment described below, the sound-shielding portion has a plate shape in which a thickness direction is substantially oriented in the vehicle width direction, but the sound-shielding portion of the present aspect is not limited thereto.

With the vehicle front structure according to a third aspect, in the first or second aspect, the sound-shielding portions are configured such that a space between the sound-shielding portions in the vehicle width direction gradually increases in a downward direction.

In the present aspect, the sound-shielding portions are configured such that the space between the sound-shielding portions in the vehicle width direction gradually increases in the downward direction.

Therefore, the generation of a standing wave between the sound-shielding portions can be suppressed. In addition, the volume of the sound can be increased.

With the vehicle front structure according to a fourth aspect, in any one of the first to third aspects, the upper through portion is a depressed portion that is open to a rear side.

In the present aspect, the upper through portion is the depressed portion that is open to the rear side.

Therefore, providing the upper through portion is easy as compared with an aspect in which the upper through portion is a through hole.

In the embodiment described below, the upper through portion is open to the rear side and is a depressed portion having a substantially trapezoidal shape in which the rear side is wide in an upper surface view, but the present aspect is not limited thereto.

With the vehicle front structure according to a fifth aspect, in any one of the first to fourth aspects,

the vehicle front structure further includes an approach notification sound speaker provided at a position lower than the absorber in addition to the horn, in which a harness connected to the approach notification sound speaker passes through the upper through portion and the lower through portion of the absorber in an up-down direction.

In the present aspect, the vehicle front structure includes the approach notification sound speaker provided at the position lower than the absorber in addition to the horn. Then, the harness connected to the approach notification sound speaker passes through the upper through portion and the lower through portion of the absorber in the up-down direction. Therefore, the upper through portion and the lower through portion of the absorber can be utilized as a portion through which the harness of the approach notification sound speaker passes in the up-down direction.

As described above, according to the present disclosure, it is possible to reduce the weight of the absorber, to improve the impact absorption characteristic of the absorber, and to increase the volume of the horn sound transmitted from the lower opening portion to the front side of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing a vehicle front structure;

FIG. 2 is a cross-sectional view of a bumper reinforcement and an absorber;

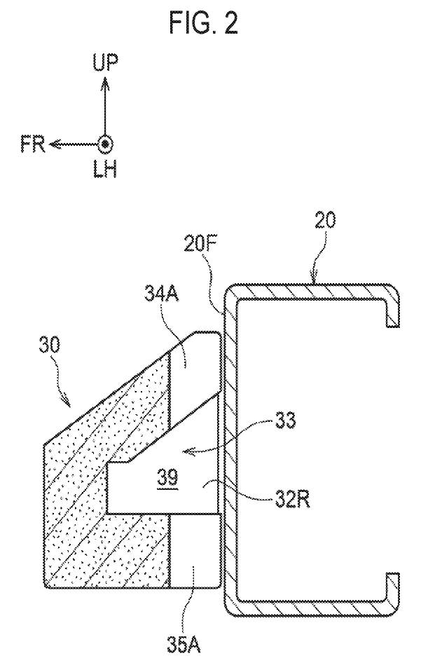

FIG. 3 is a perspective cross-sectional view of an absorber;

FIG. 4 is an enlarged rear view of the absorber; and

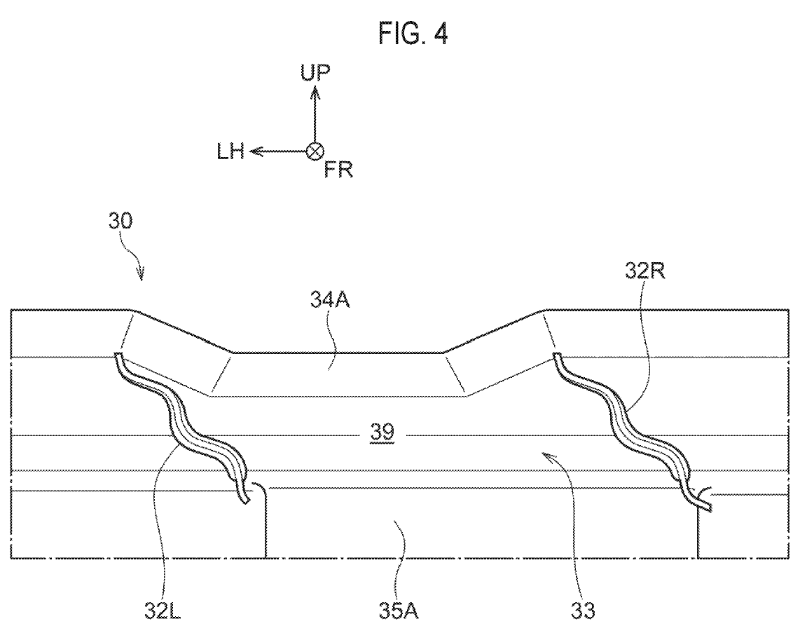

FIG. 5 is an enlarged rear view of an absorber according to a modification.

### DETAILED DESCRIPTION OF EMBODIMENTS

Hereinafter, a vehicle front structure S according to an embodiment will be described.

In addition, an arrow FR shown in each of the drawings indicates a front of the vehicle, an arrow UP indicates an upper side of the vehicle, and an arrow LH indicates a left side in a vehicle width direction. In addition, in the following description, when the front-rear, the up-down, and the right-left directions are used without special mention, the front-rear direction of the vehicle, the up-down direction of the vehicle, and the right-left direction in the vehicle width direction are indicated.

The vehicle front structure S is a front structure of a battery electric vehicle (BEV). The vehicle front structure S is a structure for improving a volume of the horn sound transmitted to a front of the vehicle.

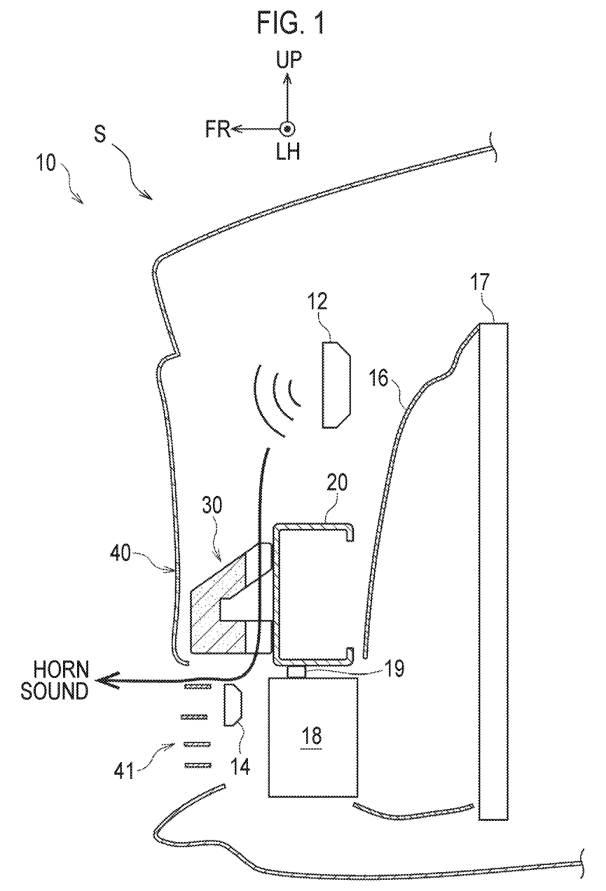

As shown in FIG. 1, the vehicle front structure S includes a horn 12, a bumper reinforcement 20, an absorber 30, a bumper cover 40, and an approach notification sound speaker 14.

The horn 12 is provided at a front portion of the vehicle. The horn 12 is disposed to face a front side of the vehicle, for example. The horn 12 is fixed to, for example, a radiator support (not shown).

The bumper reinforcement 20 is provided below the horn 12 and extends in the vehicle width direction.

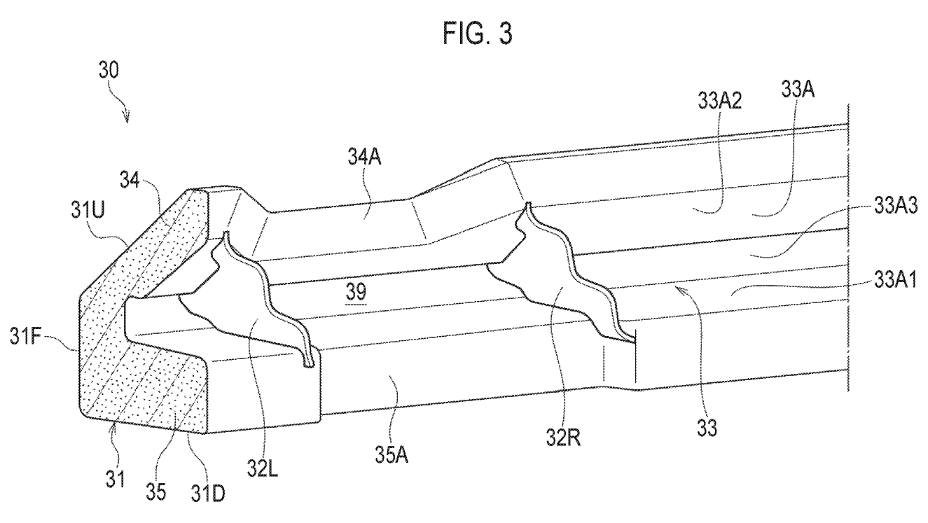

The absorber 30 is provided in front of the bumper reinforcement 20 and extends in the vehicle width direction along the bumper reinforcement 20. As shown in FIG. 3, the absorber 30 includes an absorber body 31 and a pair of sound-shielding portions 32L, 32R. The absorber 30 is provided as, for example, a foamed body and is made by, for example, a bead foaming method. Therefore, the sound-shielding portion 32 is integrally molded with the absorber body 31 using the same material as the absorber body 31. When the sound-shielding portions 32L, 32R are described without special distinction, the sound-shielding portions 32L, 32R are simply referred to as sound-shielding portions 32.

The absorber body 31 has a recess 33 extending in the vehicle width direction. The recess 33 provides an internal space extending in the vehicle width direction between the bumper reinforcement 20 and the recess 33.

The recess 33 is provided for the purpose of reducing the material of the absorber 30 as a foamed body, reducing the weight of the absorber 30, adjusting the impact absorption characteristic of the absorber 30, and the like. Although not shown, the recess 33 is provided in a center portion in the vehicle width direction in a case where the absorber body 31 is divided into the center portion in the vehicle width direction, a first side portion in the vehicle width direction, and a second side portion in the vehicle width direction.

An inner surface 33A of the recess 33 has a substantially V shape. Specifically, the inner surface 33A of the recess 33 has a bottom surface 33A1. The bottom surface 33A1 faces a direction substantially parallel to the upward direction. The inner surface 33A of the recess 33 has a top surface 33A2. The top surface 33A2 faces a direction that is inclined rearward in the downward direction. The inner surface 33A of the recess 33 has a front side surface 33A3. The front side surface 33A3 faces a direction substantially parallel to the rearward direction.

The absorber body 31 has an upper wall portion 34 that is positioned above a space in the recess 33 and a lower wall portion 35 that is positioned below the space in the recess 33.

The absorber 30 has an upper through portion 34A provided in the upper wall portion 34. The upper through portion 34A connects the space above the absorber 30 and the internal space. The sound from the horn 12 is transmitted into the recess 33 through the upper through portion 34A. The upper through portion 34A penetrates the upper wall portion 34 in the up-down direction. The upper through portion 34A is a depressed portion that is open to the rear side. The sound from the horn 12 can pass between the upper through portion 34A and the front surface 20F of the bumper reinforcement 20.

The absorber 30 has a lower through portion 35A provided in the lower wall portion 35. The lower through portion 35A connects the space below the absorber 30. The sound from the horn 12 transmitted into the recess 33 is transmitted below the absorber 30 through the lower through portion 35A. The lower through portion 35A penetrates the lower wall portion 35 in the up-down direction. The lower through portion 35A is a depressed portion that is open to the rear side. The sound from the horn 12 can pass between the lower through portion 35A and the front surface 20F of the bumper reinforcement 20.

The upper through portion 34A and the lower through portion 35A are also used for the harness of the approach notification sound speaker 14 to pass. The approach notification sound speaker 14 is disposed below the absorber 30 and the bumper reinforcement 20.

Each of the sound-shielding portions 32L, 32R has a plate shape in which a thickness direction is substantially oriented in the vehicle width direction. Specifically, each of the sound-shielding portions 32L, 32R has a plate shape in which a thickness direction is substantially oriented in the vehicle width direction and the plate shape is provided in a corrugated shape. Therefore, for each of the sound-shielding portions 32L, 32R, the surface on a side facing the communication space 39 also has a corrugated shape.

The sound-shielding portions 32L, 32R partition the communication space 39 that is connected to the upper through portion 34A and the space that is adjacent to the communication space 39 in the vehicle width direction in the internal space provided by the recess 33. The sound-shielding portion 32 may be referred to as a partition wall 32. As a result, the sound-shielding portions 32L, 32R prevent the sound transmitted to the communication space 39 that is a portion connected to the upper through portion 34A in the recess 33 from being transmitted in the vehicle width direction in the recess 33.

One sound-shielding portion 32 is provided on the first side in the vehicle width direction with respect to a portion of the recess 33 that is connected to the upper through portion 34A.

The other sound-shielding portion 32 is provided on the second side in the vehicle width direction with respect to the portion of the recess 33 that is connected to the upper through portion 34A.

The sound-shielding portion 32L on the first side is provided to connect the end of the upper through portion 34A on the first side in the vehicle width direction and the end of the lower through portion 35A on the first side in the vehicle width direction. The sound-shielding portion 32R on the second side is provided to connect the end of the upper through portion 34A on the second side in the vehicle width direction and the end of the lower through portion 35A on the second side in the vehicle width direction.

An end of the upper through portion 34A on the first side in the vehicle width direction is shifted in the vehicle width direction relative to an end of the lower through portion 35A on the first side in the vehicle width direction.

An end of the upper through portion 34A on the second side in the vehicle width direction is shifted in the vehicle width direction relative to an end of the lower through portion 35A on the second side in the vehicle width direction.

As a result, each of the sound-shielding portions 32L, 32R is provided to be inclined with respect to the up-down direction.

Incidentally, the sound-shielding portions 32L, 32R extend in the up-down direction in substantially parallel directions to each other. Therefore, there is a possibility that a standing wave is generated between the sound-shielding portions 32L, 32R. Therefore, each of the sound-shielding portions 32L, 32R has a corrugated shape to suppress the generation of the standing wave.

As a result, the generation of the standing wave is suppressed, so that the sound in the space of the absorber 30 is diffused and the attenuation of the volume of the sound due to the interference of the sounds with each other can be suppressed.

A front surface 31F of the absorber body 31 faces a direction substantially parallel to a forward direction. A lower surface 31D of the absorber body 31 faces a direction substantially parallel to a downward direction. An upper surface 31U of the absorber body 31 faces a direction that is inclined forward in an upward direction.

The absorber 30 has an upper rear surface 31B1 and a lower rear surface 31B2. The recess 33 is positioned between the upper rear surface 31B1 and the lower rear surface 31B2. The upper rear surface 31B1 and the lower rear surface 31B2 face a direction substantially parallel to a rearward direction. The upper rear surface 31B1 and the lower rear surface 31B2 face the front surface 20F of the bumper reinforcement 20.

The upper through portion 34A has a substantially trapezoidal shape in an upper surface view. That is, the vehicle width direction dimension at the front end of the upper through portion 34A is smaller than the vehicle width direction dimension at the rear end of the upper through portion 34A.

The bumper cover 40 covers the bumper reinforcement 20 and the absorber 30 from the front side. The bumper cover 40 has a lower opening portion 41. The lower opening portion 41 is provided at a position lower than the absorber 30.

The vehicle front structure S includes an air guide duct 16. The outside air introduced from the lower opening portion 41 is guided to the radiator 17 through the air guide duct 16. The air guide duct 16 is disposed in a region including the rear of the bumper reinforcement 20.

The vehicle front structure S includes a grill shutter 18. The grill shutter 18 is provided below the bumper reinforcement 20. The grill shutter 18 is configured to automatically open and close according to the traveling speed or the like. A seal member 19 is disposed in a gap in the up-down direction between the grill shutter 18 and the bumper reinforcement 20.

The sound generated by the horn 12 is transmitted to the front side of the vehicle through the upper through portion 34A, the communication space 39, and the lower through portion 35A of the absorber 30, and then through the lower opening portion 41.

### Action and Effect

Next, action and effect of the present embodiment will be described.

In the present embodiment, as shown in FIG. 1, the vehicle front structure S includes a horn 12, a bumper reinforcement 20, an absorber 30, and a bumper cover 40 that covers the bumper reinforcement 20 and the absorber 30 from a front side. Here, the bumper reinforcement 20 is provided below the horn 12 and extends in the vehicle width direction. The absorber 30 is provided in front of the bumper reinforcement 20 and extends in the vehicle width direction along the bumper reinforcement 20. The bumper cover 40 has a lower opening portion 41 provided at a position lower than the absorber 30.

In addition, in the present embodiment, as shown in FIG. 3, the absorber 30 has a recess 33 that provides an internal space extending in the vehicle width direction between the absorber 30 and the bumper reinforcement 20. Therefore, it is possible to reduce the weight of the absorber 30 and to adjust the impact absorption characteristic.

Incidentally, the lower opening portion 41 of the bumper cover 40 is provided at a position lower than the absorber 30. Therefore, the sound from the horn 12 may be blocked by the bumper reinforcement 20 or the absorber 30 and may not be easily transmitted from the lower opening portion 41 to the front side of the vehicle. Therefore, in the present embodiment, as shown in FIG. 3, the absorber 30 has the upper through portion 34A, the communication space 39, and the lower through portion 35A that connects the space below the absorber 30. Here, the upper through portion 34A connects the space above the absorber 30 and the internal space. The communication space 39 is connected to the upper through portion 34A in the internal space. Therefore, the sound from the horn 12 provided above the absorber 30 can be transmitted to the side below the absorber 30 through the upper through portion 34A, the communication space 39, and the lower through portion 35A.

As described above, the recess 33 extends in the vehicle width direction. Therefore, after entering the internal space provided by the recess 33 from the upper through portion 34A, the sound is transmitted in the vehicle width direction in the recess 33. This may cause a reduction in the volume of the sound transmitted from the lower opening portion 41 to the front side of the vehicle. Therefore, in the present embodiment, as shown in FIG. 3, the absorber 30 has the sound-shielding portions 32L, 32R. The sound-shielding portions 32L, 32R partition the communication space 39 that is connected to the upper through portion 34A and the space that is adjacent to the communication space 39 in the vehicle width direction in the internal space provided by the recess 33. Therefore, the sound is suppressed from being transmitted in the vehicle width direction in the recess 33, and as a result, the volume of the sound transmitted from the lower opening portion 41 to the front side of the vehicle can be increased.

In addition, in the present embodiment, as shown in FIG. 3, a surface on a side of at least one of the sound-shielding portions 32L, 32R that faces the communication space 39 has a corrugated shape. Therefore, the generation of the standing wave between the sound-shielding portions 32L, 32R can be suppressed.

In addition, in the present embodiment, as shown in FIG. 3, the upper through portion 34A is a depressed portion that is open to the rear side. Therefore, providing the upper through portion 34A is easy as compared with an aspect in which the upper through portion 34A is a through hole.

In addition, in the present embodiment, as shown in FIG. 1, the vehicle front structure S includes the approach notification sound speaker 14 provided at a position lower than the absorber 30 in addition to the horn 12. Then, the harness connected to the approach notification sound speaker 14 passes through the upper through portion 34A and the lower through portion 35A of the absorber 30 in the up-down direction.

Therefore, the upper through portion 34A and the lower through portion 35A of the absorber can be utilized as a portion through which the harness of the approach notification sound speaker 14 passes in the up-down direction.

In addition, in the present embodiment, as shown in FIG. 3, the sound-shielding portions 32L, 32R have a plate shape in which a thickness direction is substantially oriented in the vehicle width direction. Therefore, providing the sound-shielding portions 32L, 32R is easy.

In addition, in the present embodiment, the sound-shielding portions 32L, 32R are integrally molded with the absorber body 31. Therefore, the increase in the number of components can be suppressed.

In addition, in the present embodiment, the sound-shielding portions 32L, 32R are made of the same material as the absorber body 31. Therefore, the absorber 30 having the sound-shielding portions 32L, 32R is easily manufactured.

In addition, in the present embodiment, as shown in FIG. 1, the bumper cover 40 does not include an opening portion (upper opening portion) provided at a position above the absorber 30. Therefore, the design quality of the vehicle 10 can be improved.

In addition, in the present embodiment, the upper through portion 34A is provided at a position where the position in the vehicle width direction overlaps at least a part of the horn 12. Therefore, the volume of the sound that comes out of the lower opening portion 41 can be increased. The upper through portion 34A may be provided at a position where the position in the vehicle width direction overlaps an entirety of the horn 12.

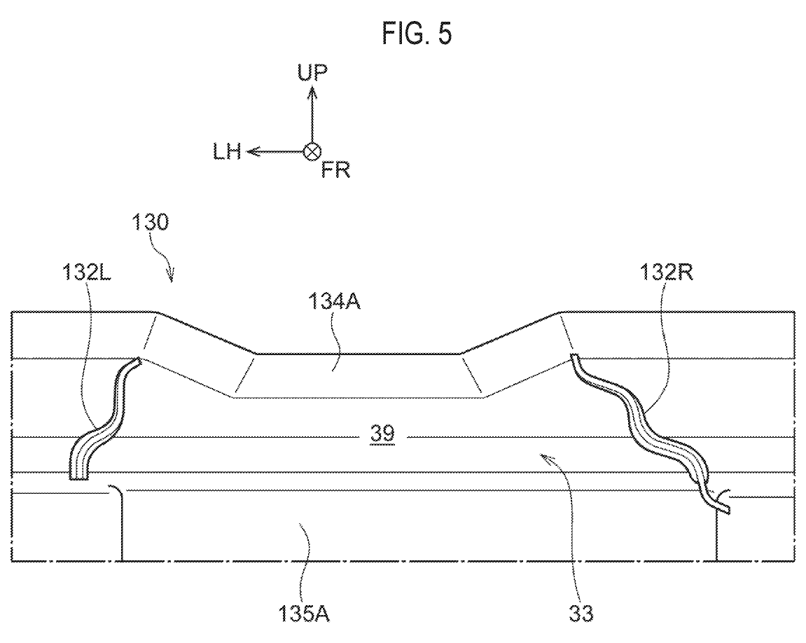

FIG. 5 shows the absorber 130 of the modification.

The sound-shielding portions 132L, 132R of the absorber 130 are inclined with respect to the up-down direction, and the inclination direction of the sound-shielding portions 132L, 132R with respect to the up-down direction is a direction different from the other. As a result, the sound-shielding portions 132L, 132R are configured such that a spacing between the sound-shielding portions 132L, 132R in the vehicle width direction gradually increases in the downward direction. The lower ends of the sound-shielding portions 132L, 132R are connected to the ends of the lower through portion 135A on both sides in the vehicle width direction. The vehicle width direction dimension of the lower through portion 135A is larger than the vehicle width direction dimension of the upper through portion 134A.

In the absorber 130 of the modification, the sound-shielding portions 132L, 132R are configured such that a spacing between the sound-shielding portions 132L, 132R in the vehicle width direction gradually increases in the downward direction. Therefore, the generation of the standing wave between the sound-shielding portions 132L, 132R can be suppressed, and the volume of the sound can be increased. In FIG. 5, both of the sound-shielding portions 132L, 132R are inclined with respect to the up-down direction, but the above-described effect is not limited to such a configuration.

Although the preferred embodiment of the present disclosure has been described above, the present disclosure is not limited to the above description.

What is claimed is:

1. A vehicle front structure comprising:
a horn;
a bumper reinforcement provided below the horn and extending in a vehicle width direction;
an absorber provided forward of the bumper reinforcement and extending in the vehicle width direction along the bumper reinforcement; and
a bumper cover configured to cover the bumper reinforcement and the absorber from a front side, wherein:
the bumper cover includes a lower opening portion provided at a position lower than the absorber; and
the absorber includes
a recess that provides an internal space extending in the vehicle width direction between the bumper reinforcement and the absorber,
an upper through portion that connects a space above the absorber and the internal space,
a lower through portion that connects a communication space in the internal space, the communication space being connected to the upper through portion, and a space below the absorber, and
a pair of sound-shielding portions that partitions the communication space and a space in the internal space, the space being adjacent to the communication space in the vehicle width direction.

2. The vehicle front structure according to claim 1, wherein a surface on a side of at least one of the sound-shielding portions that faces the communication space has a corrugated shape.

3. The vehicle front structure according to claim 1, wherein the sound-shielding portions are configured such that a space between the sound-shielding portions in the vehicle width direction gradually increases in a downward direction.

4. The vehicle front structure according to claim 1, wherein the upper through portion is a depressed portion that is open to a rear side.

5. The vehicle front structure according to claim 1, further comprising an approach notification sound speaker provided at a position lower than the absorber in addition to the horn, wherein a harness connected to the approach notification sound speaker passes through the upper through portion and the lower through portion of the absorber in an up-down direction.
